(19) United States
(12) Patent Application Publication
(10) Pub. No.: US 2019/0122183 A1
(43) Pub. Date: Apr. 25, 2019

(54) BLOCKCHAIN SCHEDULING

(71) Applicant: Calendar Tree, Inc. d/b/a WhenHub, Pleasanton, CA (US)

(72) Inventors: Nik KALYANI, Mountain View, CA (US); Scott Adams, Pleasanton, CA (US); Quin Harker, Pleasanton, CA (US)

(21) Appl. No.: 16/168,346

(22) Filed: Oct. 23, 2018

Related U.S. Application Data
(60) Provisional application No. 62/575,877, filed on Oct. 23, 2017.

(51) Int. Cl. G06Q 10/10; G06Q 30/08; H04L 9/08; G06F 17/30

(52) U.S. Cl. CPC G06Q 10/1095; G06Q 30/08; H04L 2209/38; G06F 17/30283; H04L 9/0861

(57) ABSTRACT

A method of coordinating by a server computer with a processor and memory, the server computer in communication with a network, receiving a profile information from a mobile device of a first user over the network; associating the received profile information of the first user with an account of the first user; receiving a calendar slot from the mobile device of the first user over the network; and receiving a communication type from the mobile device of the first user, related to the calendar slot over the network. Receiving a request from a mobile device of a second user over the network, to secure the calendar slot of the first user, wherein an account of the second user is previously associated to the second user; receiving a blockchain token from an account associated with the second user over the network; establishing a smart contract.

### CROSS REFERENCE TO RELATED APPLICATION

This application claims priority to U.S. Provisional Application 62/575,877 filed 23 Oct. 2017, which is hereby incorporated by reference in its entirety.

### FIELD

The field includes blockchain implementation of bidding and appointment scheduling. Networked services and data processing are invoked.

### BACKGROUND

Time is one of the most precious resources a person has. Efficient use of that time is the best way to maximize that resource. Currently, if a person wishes to maximize their efficient use of time, they must cobble together a multitude of disparate technologies to 1) advertise their free time; 2) schedule appointments within that free time; 3) only schedule the most profitable appointments in that free time; and 4) securely transact for those appointments. Pen and ink calendars cannot be used to obtain these kinds of scheduling and transactions because there is no way to coordinate the schedules while filling the time slots with the highest bidder. Thus, a technical problem exists that is currently hindering growth and efficiency in the workforce.

The systems and methods here provide for technical solutions to this technical problem using a coordinated networked approach.

### SUMMARY

Systems and methods here may be used to provide a proprietary blockchain coin, a personal scheduling interface, a bidding interface, and a secure way to fulfill interaction agreements.

In some examples, systems and methods here may include coordinating, including, by a server computer with a processor and memory, the server computer in communication with a network, receiving a profile information from a mobile device of a first user, over the network, associating the received profile information of the first user with an account of the first user, receiving a calendar slot from the mobile device of the first user, over the network, receiving a communication type from the mobile device of the first user, related to the calendar slot, over the network, receiving a request from a mobile device of a second user, over the network, to secure the calendar slot of the first user, wherein an account of the second user is previously associated to the second user, receiving a blockchain token from an account associated with the second user, over the network, establishing a smart contract between the account of the first user and the account of the second user, based on the requested calendar slot, and including the received blockchain token, verifying a smart contract trigger, based on the communication type, and executing the smart contract after the calendar slot has elapsed by transferring the received blockchain token from the account of the second user to the account of the first user.

Additionally or alternatively, the communication type is at least one of, audio, video, and text. Additionally or alternatively the communication type is in person, and wherein the smart contract trigger is a geo location proximity trigger between the mobile device of the first user and the mobile device of the second user. Additionally or alternatively the communication type is audio and at the time of the calendar slot, allowing an audio connection between the application running on the first mobile device and the application running on the second mobile device for the calendar slot duration. Additionally or alternatively the communication type is text and at the time of the calendar slot, allowing a text connection between the application running on the first mobile device and the application running on the second mobile device for the calendar slot duration. Additionally or alternatively the communication type is video and at the time of the calendar slot, allowing a video connection between the application running on the first mobile device and the application running on the second mobile device for the calendar slot duration. Additionally or alternatively further comprising, via the computer server, receiving a bid amount from the first user associated with the calendar slot, allowing multiple users to bid on the calendar slot, accepting the highest bid from the second user for the time slot, before receiving the blockchain token from the account associated with the second user.

### BRIEF DESCRIPTIONS

For a better understanding of the embodiments described in this application, reference should be made to the Detailed Description below, in conjunction with the following drawings in which like reference numerals refer to corresponding parts throughout the figures.

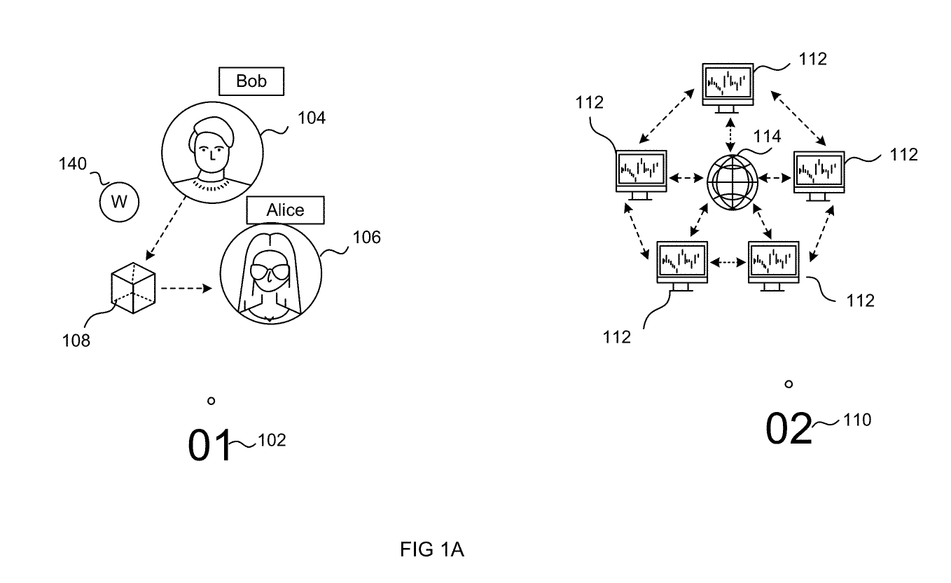

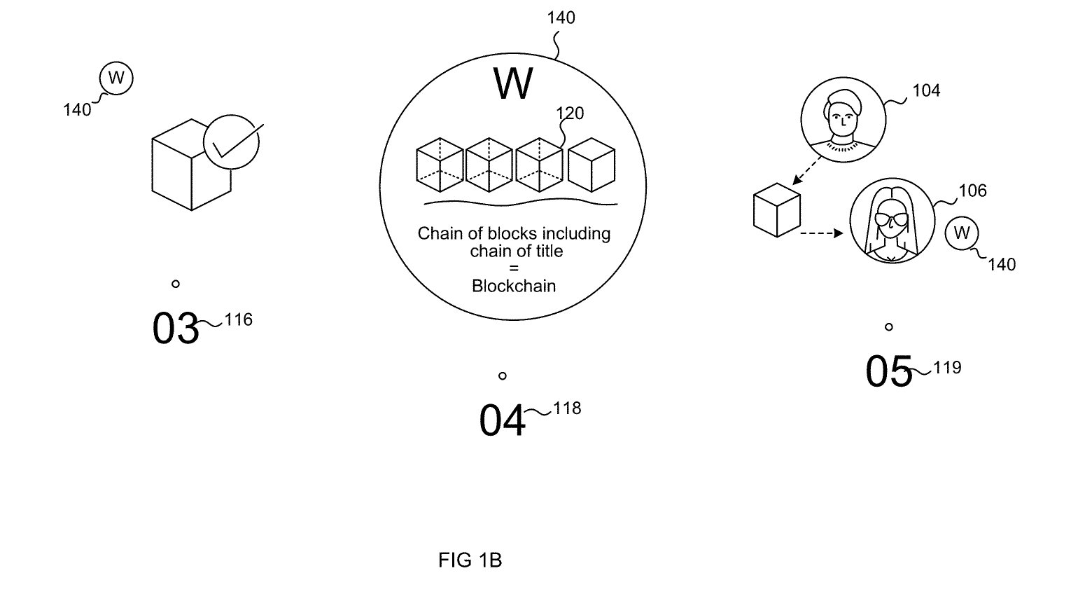

FIG. 1A is an illustration of a blockchain overview in accordance with certain aspects described herein;

FIG. 1B is a further illustration of the blockchain overview in accordance with certain aspects described herein;

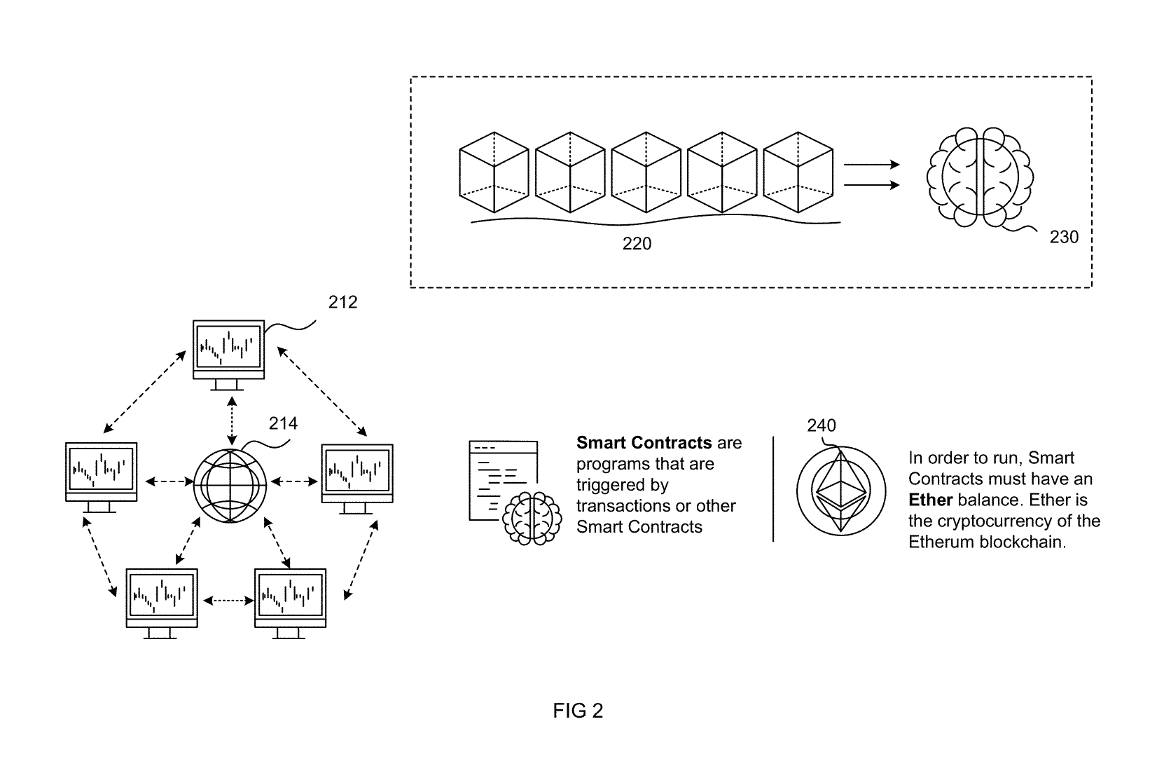

FIG. 2 is an illustration of a network diagram showing an example peer-to-peer network arrangement in accordance with certain aspects described herein;

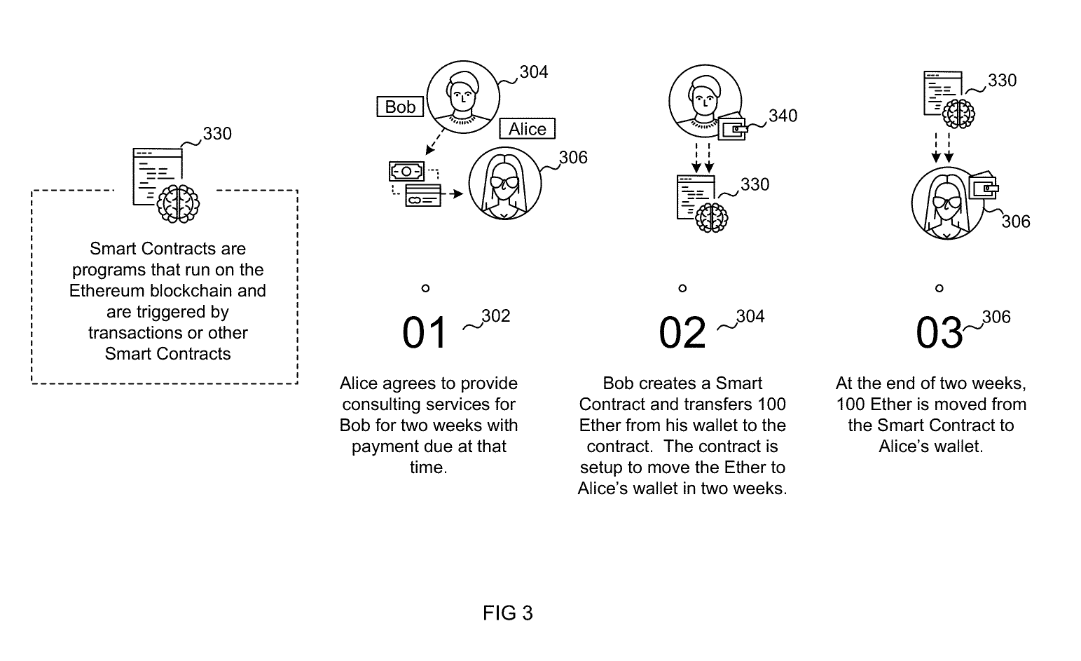

FIG. 3 is an example illustration showing an overview of smart contracts in accordance with certain aspects described herein;

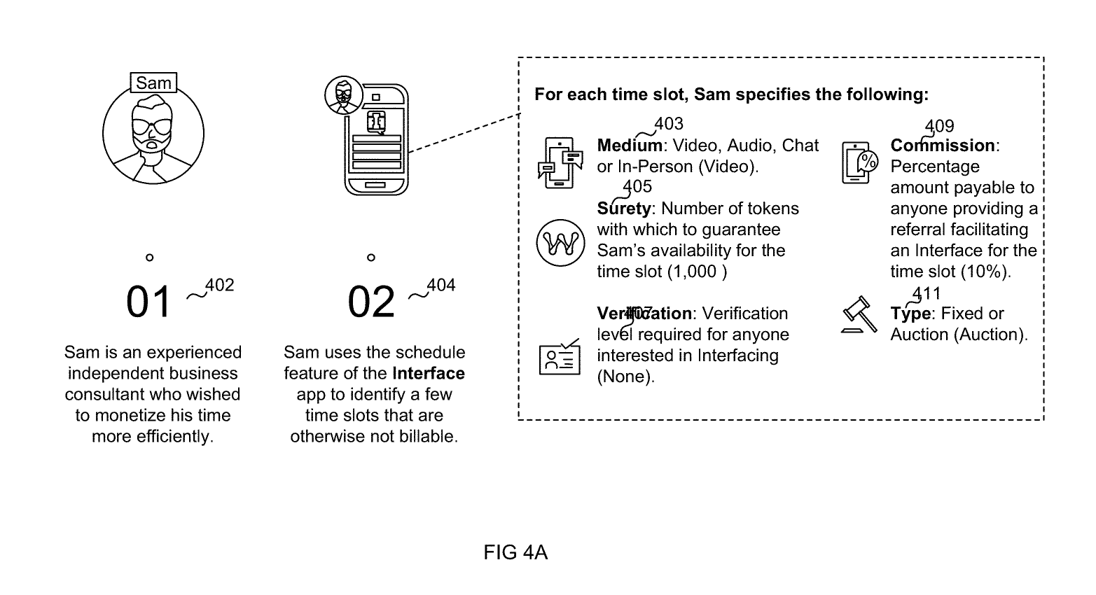

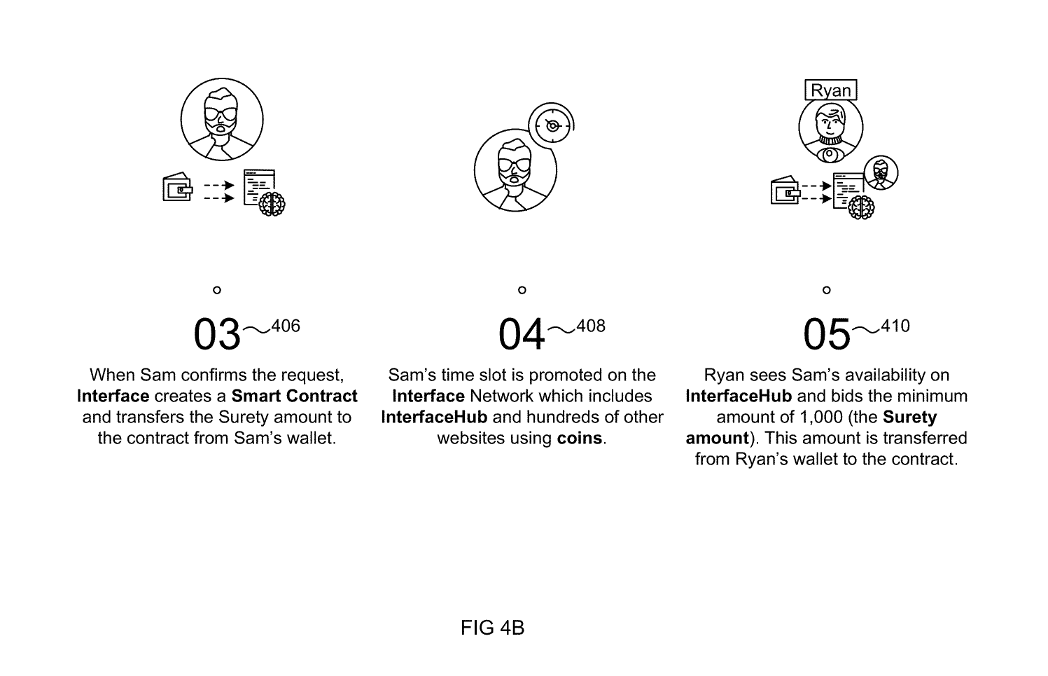

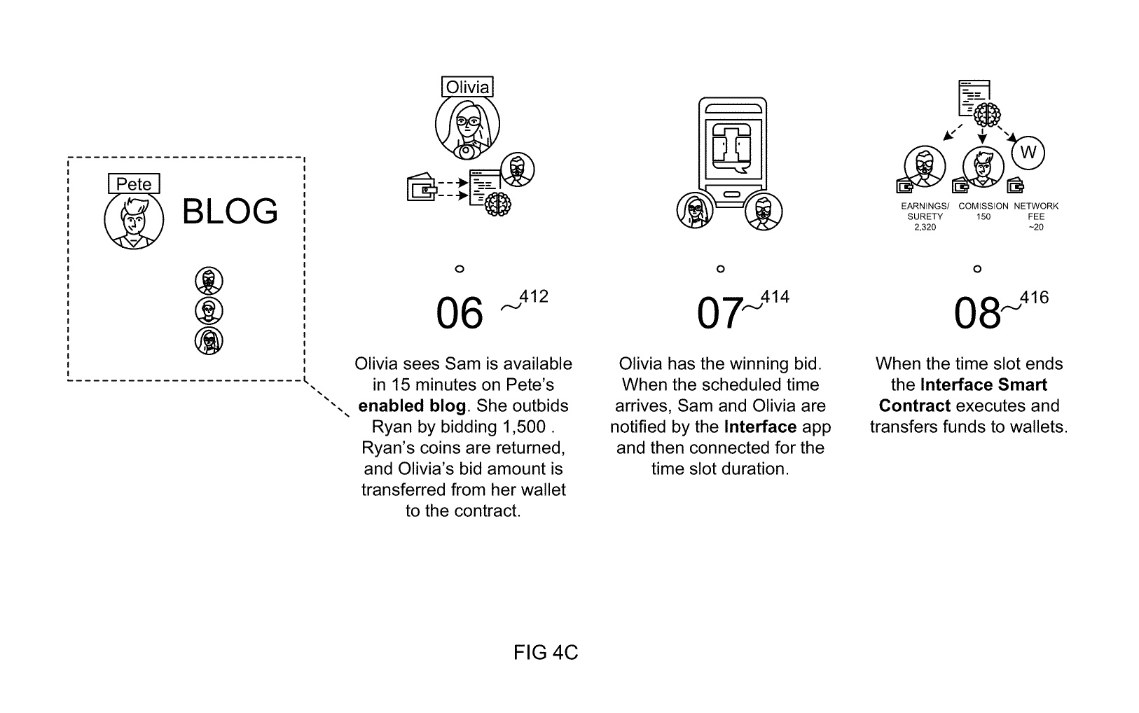

FIG. 4A-4C are example illustrations showing a scheduling interface overview in accordance with certain aspects described herein;

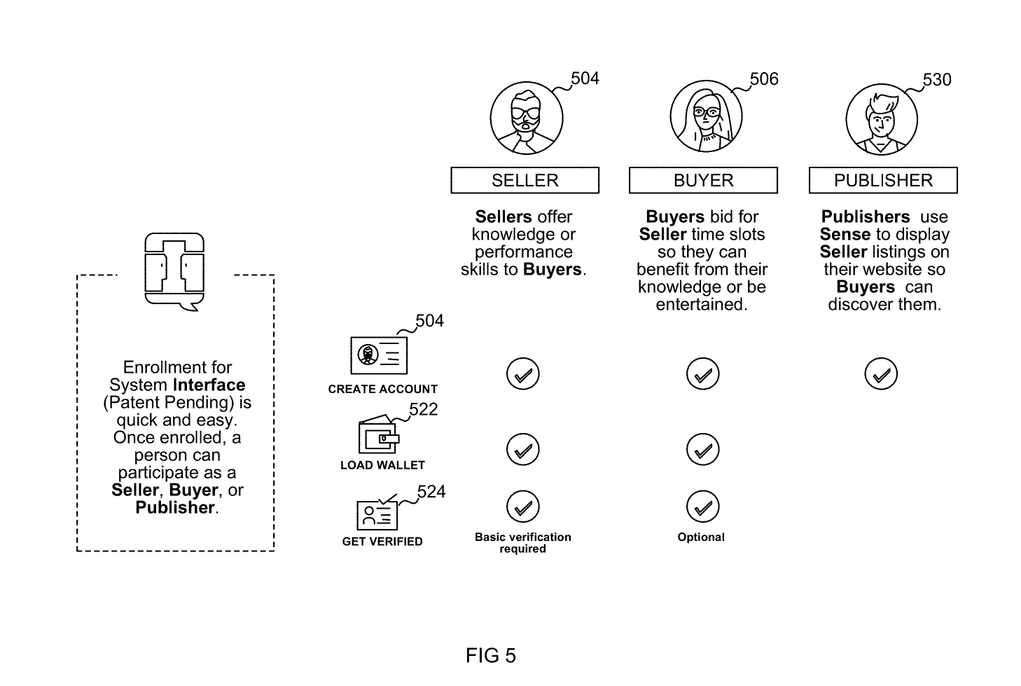

FIG. 5 is an example illustration showing a scheduling enrollment overview in accordance with certain aspects described herein;

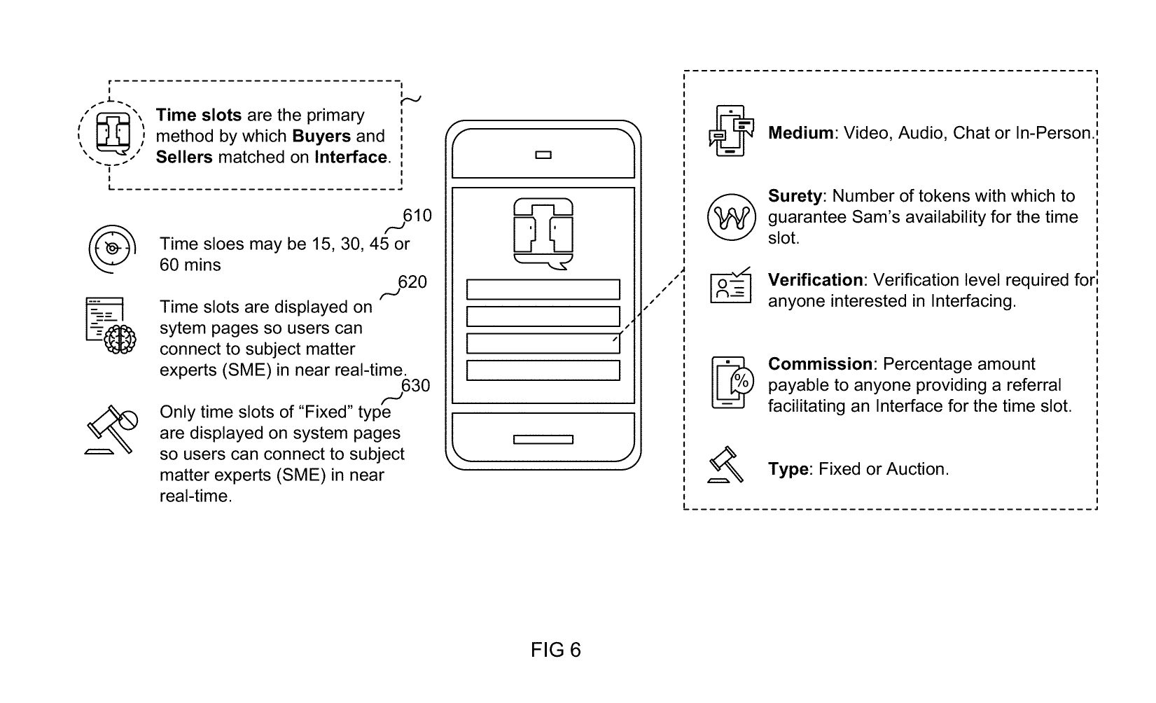

FIG. 6 is an example illustration showing a scheduling interface overview in accordance with certain aspects described herein;

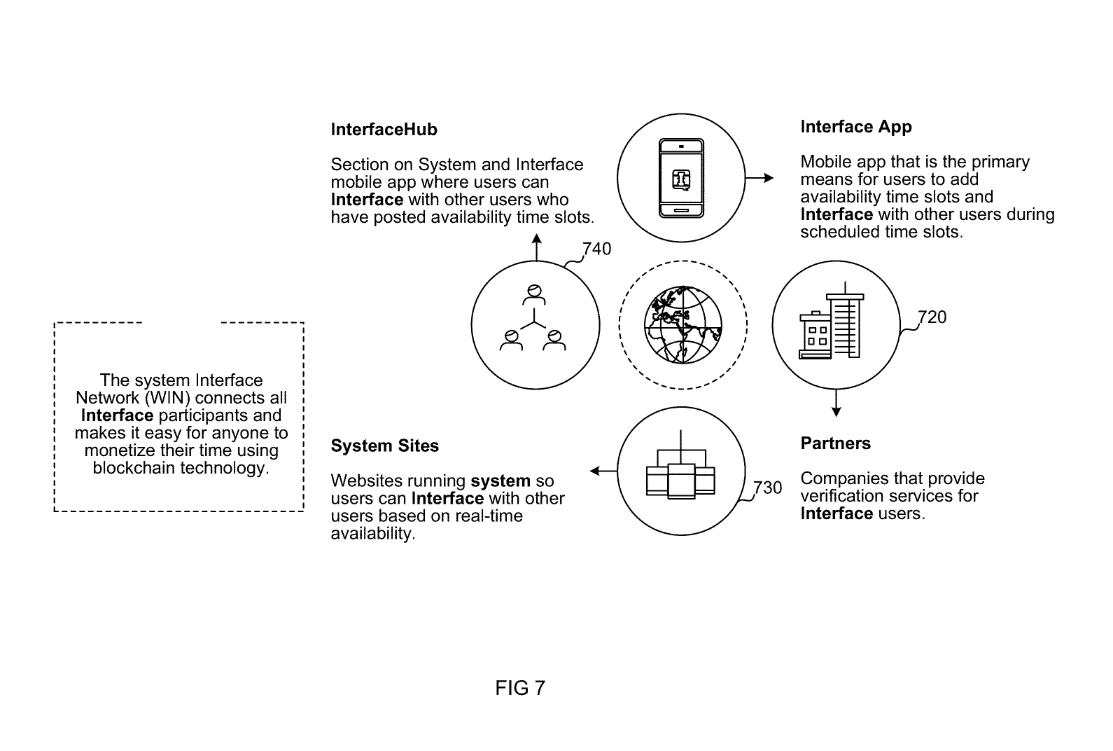

FIG. 7 is an example illustration showing a scheduling networking overview in accordance with certain aspects described herein;

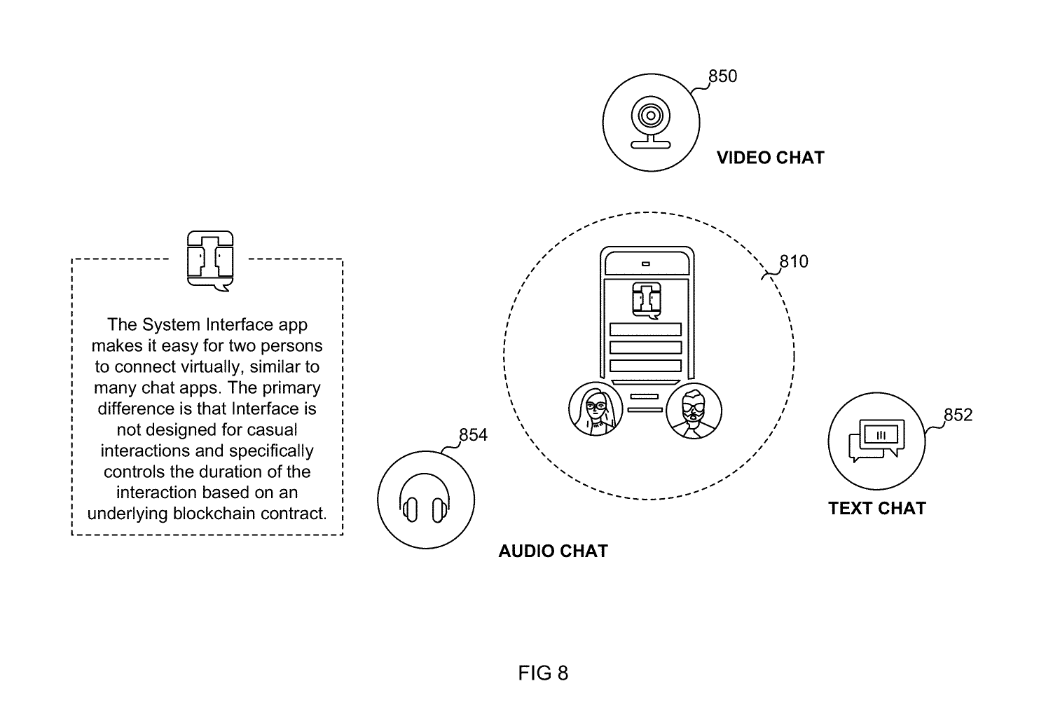

FIG. 8 is an example illustration showing an example interface networking overview in accordance with certain aspects described herein;

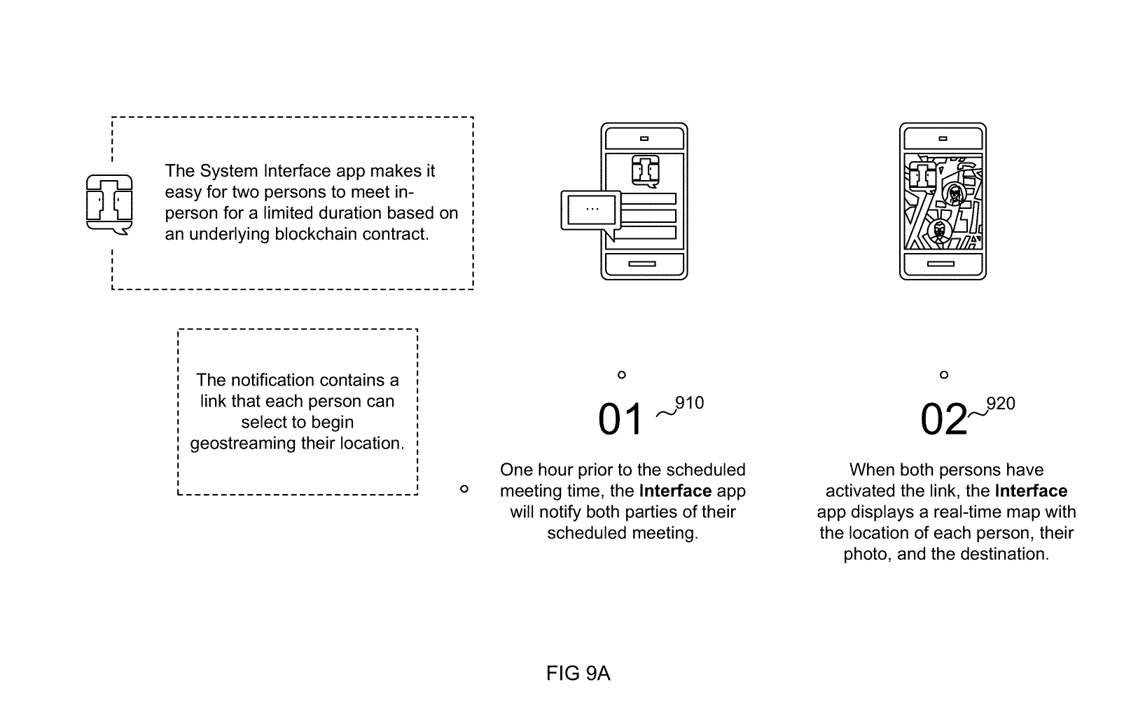

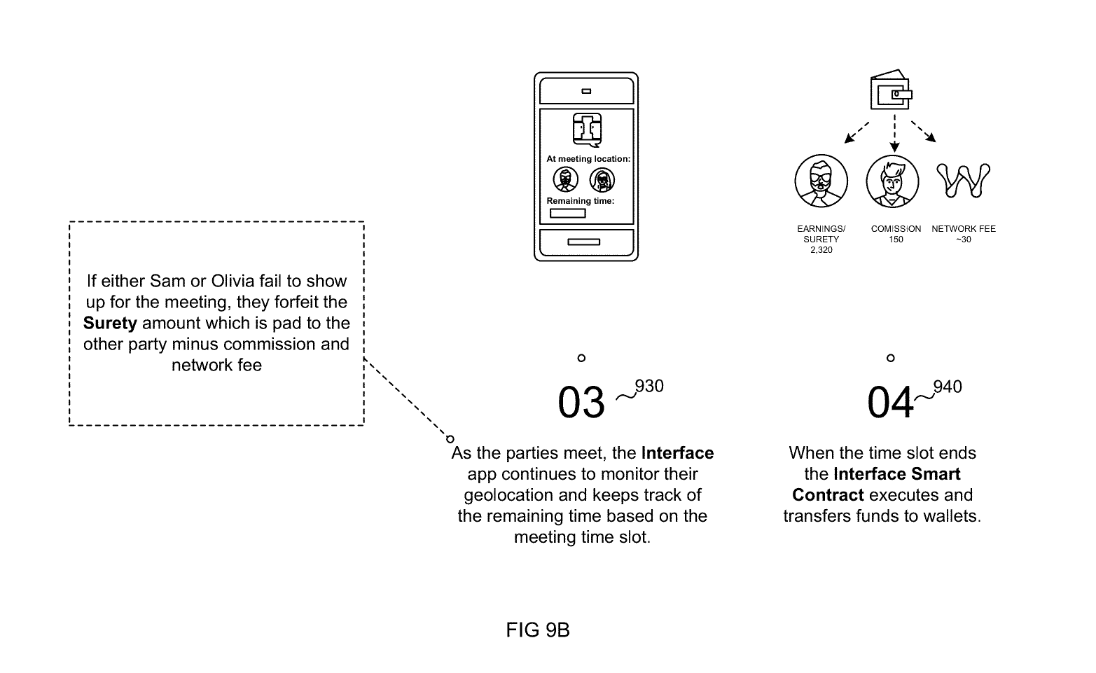

FIG. 9A-9B are an example illustrations showing an example in-person interface networking overview in accordance with certain aspects described herein; and

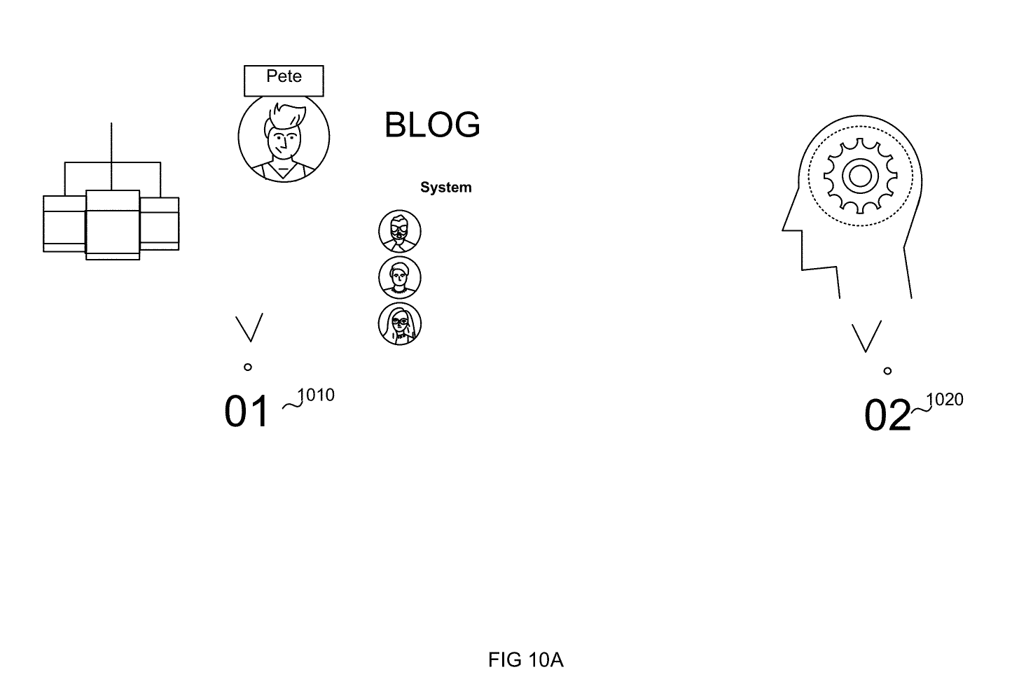

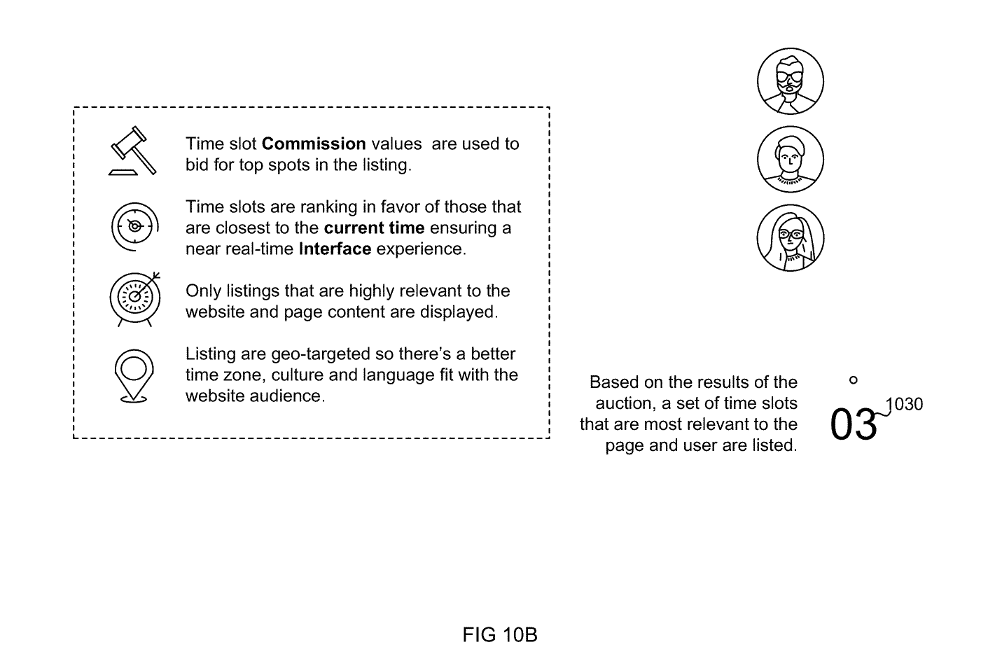

FIG. 10A-10B are an example illustrations showing an example fulfillment overview in accordance with certain aspects described herein.

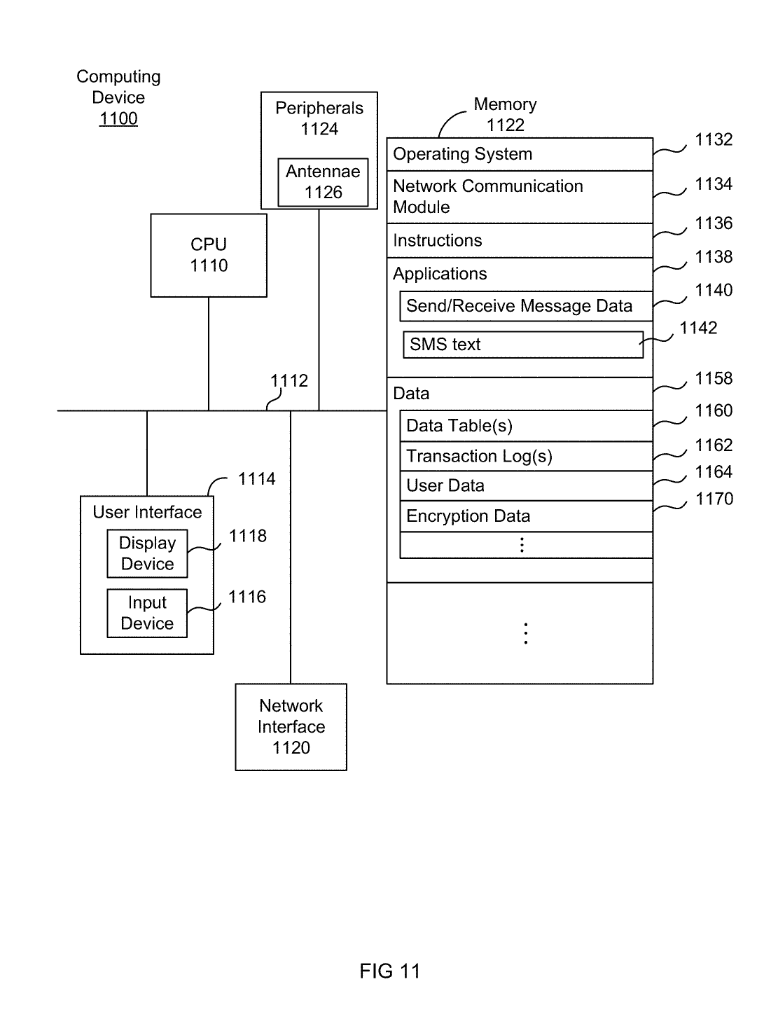

FIG. 11 is a diagram of computer hardware used to practice the certain embodiments disclosed here.

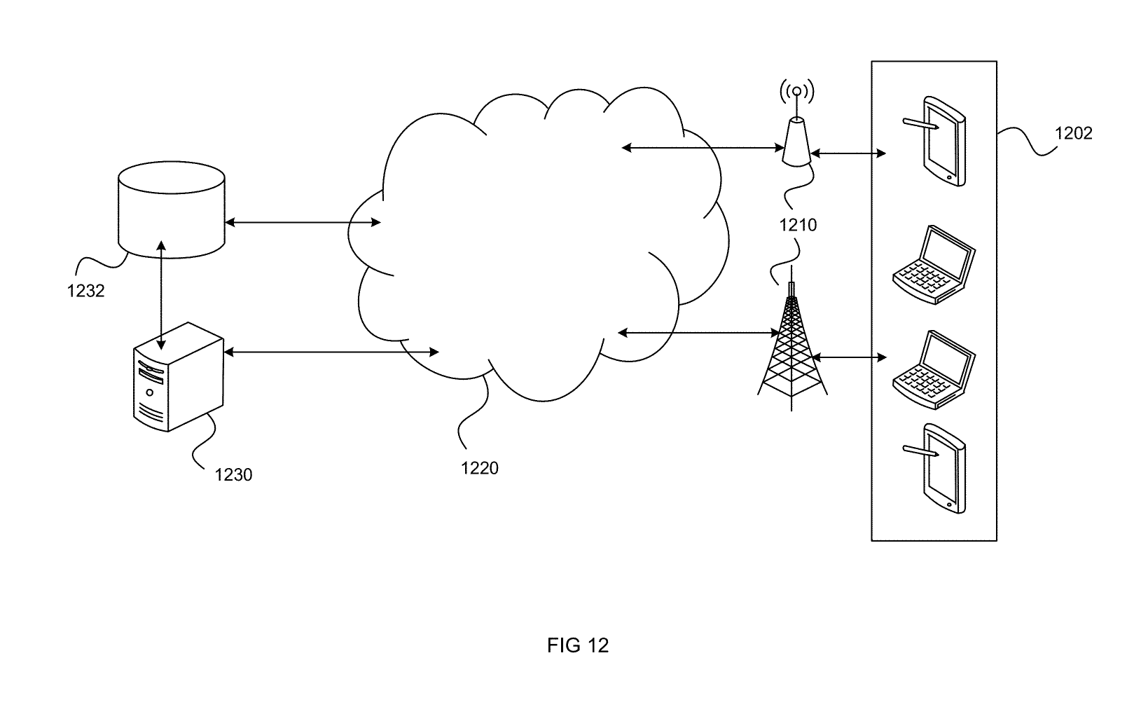

FIG. 12 is a network diagram used to practice the methods according to certain embodiments disclosed here.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

### Overview

The systems and methods here allow for users to maximize their time by advertising their calendar free time, allowing potential customers to bid on that free time.

Some embodiments allow these features to be performed on a mobile application for a smart device. In such examples, a back end system may perform certain features to allow for scheduling to be promulgated and transactions to be fulfilled as described herein.

Some example embodiments utilize a blockchain coin as the currency to bid on time. Such an arrangement allows for zero currency transactions and in some examples, anonymous transactions.

Additionally or alternatively, this blockchain arrangement allows for the use of so called “smart contracts.” Such contracts, as described herein, allow for the automatic fulfillment of a contract upon certain parameters being fulfilled. This automatic fulfillment greatly increases efficiency and decreases transaction costs to nearly zero.

### Blockchain Examples

FIGS. 1A-1B are illustrations of an example showing how blockchain may be utilized. All of the transactions in the examples occur over computer networks such as those shown in FIG. 12. In the first step 102, the first user 104 requests a transaction with a second user 104 by an application on a computing device, the communication over a network of computers. The request is a request to pass a certain token or coin 140 from one user to another. The example underlying token or coin has no intrinsic value beyond what is given to it by the users, and has no physical form itself. The token or coin 140 is not supplied by a central bank or other institution, but rather by an organization which provides the tokens or coins. The example tokens or coins 140 may be highly sophisticated encrypted algorithms that require immense computing power to compile and decipher. Thus, they are difficult to create and thereby counterfeit. In some examples, these tokens or coins are referred to as cryptocurrency.

In the example, these users have presumably arranged for a profile or account on a proprietary system 108 or application. It is with this application 108 that the users interface, through APIs. Thus, the system running the application 108 is able to allow the user profiles to be reviewed and interact with the system 108 as described herein.

In the second step 110, the requested transaction from the first instance 102, is broadcast to many multiple networked computers, sometimes referred to as “nodes” 112 over a peer-to-peer decentralized network 114. In some examples, this broadcast includes a timestamp. Each node 112 records this broadcast and timestamp as described below. Thus, without a centralized bottleneck, this system allows for robust and redundant record keeping because of its decentralized and broadcast nature. The general idea is that if many multiple nodes all receive the information about the transaction, and record the transaction along with the timestamp, the record is nearly impossible to hack, corrupt or otherwise alter. In some examples, this is referred to as a blockchain or blockchain ledger.

In some example embodiments, using this blockchain, the information may be encrypted. That is, the data which describes which users are interacting in the requested transaction 102 and/or the timestamp may be encrypted. An analysis of the encrypted data would not reveal the identities of the transacting parties, but using keys, the transacting parties may review that the transaction occurred and when it occurred.

Now referring to FIG. 1B and continuing with the blockchain example, the decentralized network is able to validate the transaction using known algorithms 116. This step ensures that there are no other transactions for this particular token or coin, that were received before the newly requested transaction 102 and that the proper encryption is in place. In other words, the system ensures that this particular coin 140 wasn't already spent by the first user 104, and that it's passing to the second user 106 follows a proper chain-of-title type flow. Next step 4, 118, once verified, the transaction is appended to a record which indicates that this particular token or coin has now been passed from the first user 104 to the second user 106 which is now the recorded owner. Over time, a chain 120 of these encrypted transaction logs may be created for each particular token or coin 140. As this record is promulgated to the nodes 112 to be saved, its record is secured in a de-centralized manner Thus, as shown in step 5, 119, after passage of the token or coin 140 to the second user 106, the first user 104 is no longer able to pass the same token or coin 140 to a third user, because in the verification step 3, 116, the network would already see that its records indicate that the second user 106 is in virtual possession of the token or coin 140. Thus, the network would reject any subsequent attempt for the first user 104 to pass the token or coin 140 to any third party. And as the transaction and records of it are all encrypted, the identifies of the two parties 104 and 106 may be kept anonymous.

### Decentralized Apps and Smart Contract Examples

Additionally or alternatively, as described in FIG. 2, in certain examples, the system allows for decentralized application deployment. As described above, a decentralized network 214 that utilizes interactions between and among computers sometimes known as nodes 212 may be used to employ a virtual machine. In some examples, each node 212 includes a copy of the blockchain ledger 220 as well as a copy of a decentralized application 230. In some examples, the decentralized application 230 may only be triggered by transactions or by other decentralized applications. That is, in order to run, certain decentralized applications may require a token or coin 240.

In some examples, Ethereum may be an open software platform based on blockchain technology that enables developers to build and deploy decentralized applications. It may include a peer-to-peer network of computers known as nodes. Each node may include a complete copy of the blockchain 220 and a Virtual Machine (VM) that is capable of running specialized programs known as Decentralized Apps (dApps) which may be referred to as Smart Contracts 230.

FIG. 3 shows an example of how a smart contract may operate in a networked computer environment. As described in FIG. 2, a smart contract 330 may be considered a decentralized computer application. They may require a blockchain token or coin 340 to operate as s key to unlock the code. In the Example of FIG. 3, first 302, the two parties 304, 306, negotiate over the network. In the example the first user 304 buys lawn care services from the second user 306 for a two week period, with payment only upon completion of the two weeks of lawn care. Next 304, the first party 304 creates a smart contract 330 and transfers the agreed upon amount of tokens or coins 340 into the contract 330. The second user 306 is not able to obtain the tokens or coins 340 when the smart contract 330 is created, as they are locked and the trigger threshold has not been met. Likewise, the first user 304 is not able to back out the tokens or coins 340 while the contract 330 is being fulfilled.

Finally 306, at the agreed upon time, the contract 330 ensures that the tokens or coins 340 will be moved to the account of the second user 306. As a blockchain transaction, such a movement would take place as described in FIG. 1A and FIG. 1B. The smart contract 330 would not require any outside influence or instruction to complete the contract and fulfill the exchange 306 as long as the programmed threshold triggers are met, thus creating a frictionless and automatic transaction. In the example, a time of two weeks is built into the smart contract 330 because that was the agreed-upon time for lawn care before payment.

It should be noted that a simple trigger of time as described in FIG. 3 is merely an example and not meant to be limiting in any way. Triggers could range from timing to an event to an acceptance or any other kind of trigger. One example trigger will be described in detail in FIG. 9A and 9B.

In certain examples using smart contracts, a network usage fee may be charged to one, both, or any combination of the users who utilize the system. In such examples, when the smart contract finalizes the transaction and moves the tokens or coins from the buyer to the seller account, a certain percentage or flat rate may be moved to the account of the operator of the network. For example, a 1% usage fee may apply to all executed smart contracts. That amount is removed from the seller's amount of tokens or coins and sent to the account of the network operator, whereas the remainders of the tokens or coins are sent to the account of the seller.

### Interface Overview Examples

FIGS. 4A, 4B, and 4C show an example interface overview of a computer application that could run on a mobile smart device. Back end servers as described in FIG. 12 may receive and send information to mobile devices or other computing devices where users interact via APIs. In the example, first 402, a user decides to post his availability on the system in order to help monetize his time.

Next 404, using the application software, the user identifies open time slots on the application, just the ones that he wants to be available to schedule. In some examples, the user is able to specify one or more variables for scheduling slots. Examples of scheduling variables that users may identify, either alone or in any combination may include, but are not limited to: medium 403 (video, audio, chat, in-person); surety 405 (number of tokens or coins needed by requester to guarantee for time slot); verification 407 (level of previous verification of identity of requester before interface); commission 409 (percentage amount payable to anyone providing a referral for facilitating an interface); and/or type 411 (fixed amount or auction bidding).

Next 406, as shown in FIG. 4B when the user finalizes selection of time slots, the system creates a smart contract and transfers the requisite number of the first user's tokens or coins from the surety amount (if there is one set) to the user's cryptocurrency account. Then 408, the time slot may be promoted by the system as available for other users to agree to. The promotion of a time slot can occur in any multiple of ways and is explained in detail in FIGS. 10A and 10B below. Finally 410, the third party requesters are shown the available time slot on the plurality of websites and/or applications. These applications allow a networked requester to bid at least the minimum amount of tokens or coins (the surety if one is set) if that third party decides to contract with the user. Then if the user had set up a fixed arrangement, the amount of tokens or coins would be transferred from the requesting user as described herein.

In the instance of an auction example embodiment, as shown in FIG. 4C, another bidder 412 sees the advertisement or solicitation on the application or website and outbids the first requesting bidder. In such an example, the first requesting bidder's tokens or coins are returned and the highest bidding user's tokens or coins are transferred to the smart contract. In the example of FIG. 4A-4C, the second user has a winning bid 414 and the auction ends. In the example shown in the figures, the system notifies the original user who set up the time availability and the winning requesting bidder when the scheduled time to interface arrives. In examples where the interface is a video or audio, the system allows for automatic connection as described below. In examples of an in-person interface, that interface is facilitated as described below Finally 416, when the time slot ends, the smart contract executes the contract and transfers the tokens or coins from the winning bidder requester user to the original user who set up the time slots.

### Interface Enrollment Examples

In the example shown in FIG. 5 a user who wants sell time 504 can set up an account on the system 520. The seller user 504 may then load an account or virtual wallet with tokens or coins 522. The seller user 504 may also get verified by the system 524 in any of various ways. Such a verification may help ensure to any of the potential buyers that the seller is an expert in what he/she purports to be an expert in. In some example embodiments, buyer users may rate the seller users using the system, and thereby create a culture which encourages true and correct resume and capability representations by users.

In the example of FIG. 5, a potential buyer user 506 may also create an account 520, and load a virtual wallet or account 522 with tokens or coins. In some example embodiments, potential buyer users may gain verification as well. Such buyer user 504 verification may help ensure to seller users 504 that the buyer user 506 is a legitimate businessperson.

Finally, in the example, a publisher 530 described in more detail below, may establish an account on the system 520. The publishers 530 may be the publishers of internet websites that advertise the available time allotments to potential buyer users 506.

### Interface Time Slot Examples

FIG. 6 shows an example of what could be on a graphical user interface GUI or the system behind the GUI to allow for interface time slots to be advertised and bid on as described herein.

In the example, the basic commodity being sought is time 610. Such time could be in any increment, including but not limited to slots of 15, 30, 45, or 60 minutes. Hours could be used in certain example embodiments. In certain example embodiments, the advertising of the available time slots 620 may be created on various web pages as described below. The fixed type of bidding may be used in examples where the timing between bid and acceptance is short, thereby allowing for near real time bid and interface 630.

The various forms of interface, as explained could be but are not limited to audio, video, and chat, which may be facilitated by the system. Another form of in-person may be facilitated as explained below in FIGS. 9A and 9B.

### Example Interface Network

In some example embodiments, a network may be established to host the user accounts, facilitate the submission of open time slots, facilitate the bidding on time slots and coordinate the smart contracts used to fulfill the interface transaction using blockchain tokens or coins.

In the example, the network includes software used in both a back end system and as an application on a mobile device such as a smartphone. On the smartphone application 710, the users may interface with the system to post requests, place bids, move tokens or coins into smart contracts, or any other kind of interface as described here. In some examples, the network arrangement may include partners 720 which may be used to verify identities and/or capabilities of users. In such examples, when users need verification, the third party partners perform that background checks, resume checks, etc. and provide verification to the system for the requested users. This verification information may then be reflected in the user accounts on the application interface 710. In some examples, any number of websites 730 may be used to provide interfaces for real time or near real time interactions. In such examples, the websites 730 may display offers for no auction time slots, and allow bidders to bid and then interface quickly. In some examples, the system may be used to interface among users who post auction, no auction time slots and users looking to purchase those time slots 740 as described here. In such examples, potential buyer users may input criteria for seller users they wish to interact with, place bids and interact as described herein.

### Virtual Interfacing Examples

In FIG. 8, the interface application is shown 810 on a mobile device. As described herein, the application 810 allows for users to post available time slots so other users can bid on those time slots and interface for the allotted time. In examples where the interface is any one of video 850, text chat 852, or audio call 854, the system itself can facilitate that interaction using the software on the back end systems and the mobile applications 810.

For example, if the selling user posts a time slot to discuss plumbing for 1 hour at 10 am local on Wednesday, and a buyer user submits a winning bid for that time, the smart contract may facilitate payment after the time slot closes, but also create the interaction on the two mobile applications of the respective users. In other words, the application of the buyer and seller may open a video chat session, audio session and/or text chat session for just the time the contract was created. In the example, at the 10 am time, the two user's applications convert to a video/audio/text chat screen and allow for interaction. Then at 11 am, after the one hour has passed, the communication line closes automatically. In the smart contract examples, this is when the transfer of tokens or coins takes place.

In such examples, the users do not have to exchange any personal information to communicate. This allows for a level of anonymity and for a level of security so that later unauthorized or unwanted contact cannot be initiated. In other words, no email addresses, phone numbers, or other identifying information needs to be passed between the users in order for the interaction to automatically occur on the application.

In some examples, the system may allow for multiple users to interact among each other, instead of just one buyer and one seller as explained here.

### In Person Examples

The Example of FIGS. 9A and 9B explains examples where the contract is for an in-person meeting instead of an online communication session. As explained above, the system may allow for the interaction between or among the buyer and seller through the application interface, by video, text, audio or any combination of these. But in some example embodiments, the interaction may be in person. For example, if the plumber has to come to the buyer's house to fix the pipes, then the interaction may not work well as a video call.

In such example embodiments, the smart contract trigger may need to be a proximity trigger by using the geo locations of the mobile devices of the buyer and seller as described herein.

In example FIGS. 9A and 9B, the interaction for the bidding or otherwise buying of the scheduled time is assumed. The steps of FIGS. 9A and 9B begin after that step. First, 910 at some time before the meeting interaction, the application may inform the buyer and seller users that the scheduled meeting may take place. In some example embodiments, a button or other interaction may be required by the application to begin the geo location information gathering and sharing. Next 920, the application may show a map for each user, on the respective user mobile devices. In some examples, the map 920 may show the two users on the map by an indicator such as an avatar or icon. In some examples, the icon is a face from a user profile.

In FIG. 9B, the step 930 shows that the two users and their respective mobile devices reach a predetermined proximity to one another, such as but not limited to ten meters, five meters, or some other example geo location proximity. This proximity may be determined by a back end system that receives the geo location data from each respective mobile device, and compares the two. In some example embodiments, the applications on the respective mobile devices calculate rage, proximity and/or distance to the other mobile device by receiving its geo location information.

In any of the above scenarios, the system is able to determine that the two mobile devices running the mobile application are within a certain threshold of one another, and the smart contract triggers. The time slot is thereby opened. Finally, 940 when the time slot ends, the smart contract executes the transfer of tokens or coins into the respective accounts and/or wallets. This transfer may include the commission, surety, earning, network fee, or whichever combination is appropriate to the smart contract.

### Embedded Advertising Examples

FIGS. 10A and 10B show example steps that explain how real time connections may be made by advertising the interactions in third party websites. In such a way, the systems make it possible to connect users in real-time based on a website listing of their availability.

First, 1010, any third party website can opt into the program simply by adding an embed code to their page script. This code may be used by the system here to push advertising, links, or other information. An example is code like that used for Google AdSense.

Next, 1020, when a user visits a website that includes the embed code, a machine learning engine may conduct an auction. Such an auction may be conducted behind the scenes where the user is unaware or not shown the initial auction through the user interface. For example, in some example embodiments, time slot commission values may be used to bid for top spots on the listing. In some example embodiments, additionally or alternatively, time slots may be ranked in favor of those that are closest to the current time which may favor a real time or near real time experience. In some example embodiments, additionally or alternatively, only listings that are highly relevant to the individual website content and/or theme may be displayed. In some example embodiments, additionally or alternatively, listing may be geographically targeted, using a geographical location of the device that is viewing the third party website, information from that user's account, or other geographical location techniques.

Finally, 1030, based on the results of the auction, a set of time slots that are most relevant to the page and/or the user may be listed as an advertisement on the webpage. Then, as described above, the buyer user may select a seller user for an interface.

### Hardware Examples

FIG. 11 shows an example computing device 1100 that may be used in practicing the inventions described herein. Such a computer device may be used as the back end system that coordinates the user interations, such as a server computer. Such a computer may be the end user devices used to interact with the back end systems. Any of various embodiments of computers such as server computers, mainframes, user devices such as smartphones, laptops, desktops, wearables such as glasses, watches, or other devices may be used.

In FIG. 11, a processor such as a CPU 1110 is shown in communicaion by a bus 1112 or other connection to other computer components such as but not limited to a user interface 1114 which may include a display 1118, a n input device 1116 and other components. In some examples, the display may be a screen. In some examples, the input 1116 may be integrated with the screen 1118 and form a touchscreen. In some examples, the input 1116 may be a button or multiple buttons, joystick, mouse, keyboard, camera, or other device. In some examples, the computing device 1100 may include a network interface 1120 configured to commnicate with other devices over a network. In some examples, the computing device 1100 may inlcude periperals 1124 including an antennae 1126 such as a WiFi, Bluetooth, cellualar, or other antennae device configured to allow wireless communications. In some examples, the computing device 1100 may include a memory 1122 configured to run scripts of code. In some examples, the memory 1122 may include an operating system 1132, network communication modules 1134, instructions 1136, applications 1138, send/receive message data 1140, SMS short message service 1142, storage of data 1158 inlcuding data tables 1160, transaction logs 1162, user data 1164, encryption data 1170 or other data.

### Network Examples

FIG. 12 shows an example network which may be used to implement the steps described herein and work with and implement the disclsoures here. In the example, a back end computing system 1230 such as a server computer or multiple computers may be in communication with a data storage 1232. The back end sytem 1230 may be the system that implements the calendaring and/or crypto currency implementation described. The back end system 1230 may be in communcation over a network 1220 such as the Internet with any of various user computers 1202. The back end system 1230 may be a distributed of cloud based system.

Such communcation may be through wireless connection 1210 such as WiFi and/or cellular. The user computers 1202 may include any of various computer such as but not limited to laptops, smartphones, desktops, tables, or any other kind of computing device such as with component parts as shown in FIG. 11.

### Conclusion

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a general-purpose computer or computing platform selectively activated or reconfigured by code to provide the necessary functionality The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal- oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descritions pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A method of coordinating, the method comprising:
by a server computer with a processor and memory, the server computer in communication with a network,
receiving a profile information from a mobile device of a first user, over the network;
associating the received profile information of the first user with an account of the first user;
receiving a calendar slot from the mobile device of the first user, over the network;
receiving a communication type from the mobile device of the first user, related to the calendar slot, over the network;
receiving a request from a mobile device of a second user, over the network, to secure the calendar slot of the first user,
wherein an account of the second user is previously associated to the second user;
receiving a blockchain token from an account associated with the second user, over the network;
establishing a smart contract between the account of the first user and the account of the second user, based on the requested calendar slot, and including the received blockchain token;
verifying a smart contract trigger, based on the communication type; and
executing the smart contract after the calendar slot has elapsed by transferring the received blockchain token from the account of the second user to the account of the first user.

2. The method of claim 1 wherein the communication type is at least one of, audio, video, and text.

3. The method of claim 1 wherein the communication type is in person, and wherein the smart contract trigger is a geo location proximity trigger between the mobile device of the first user and the mobile device of the second user.

4. The method of claim 2 wherein the communication type is audio and at the time of the calendar slot, allowing an audio connection between the application running on the first mobile device and the application running on the second mobile device for the calendar slot duration.

5. The method of claim 2 wherein the communication type is text and at the time of the calendar slot, allowing a text connection between the application running on the first mobile device and the application running on the second mobile device for the calendar slot duration.

6. The method of claim 2 wherein the communication type is video and at the time of the calendar slot, allowing a video connection between the application running on the first mobile device and the application running on the second mobile device for the calendar slot duration.

7. The method of claim 1 further comprising, via the computer server,
receiving a bid amount from the first user associated with the calendar slot;
allowing multiple users to bid on the calendar slot;
accepting the highest bid from the second user for the time slot, before receiving the blockchain token from the account associated with the second user.

8. A non-transitory computer-readable medium having computer-executable instructions thereon for a method of coordinating, the method comprising:
receiving a profile information from a mobile device of a first user, over the network;
associating the received profile information of the first user with an account of the first user;
receiving a calendar slot from the mobile device of the first user, over the network;
receiving a communication type from the mobile device of the first user, related to the calendar slot, over the network;
receiving a request from a mobile device of a second user, over the network, to secure the calendar slot of the first user,
wherein an account of the second user is previously associated to the second user;
receiving a blockchain token from an account associated with the second user, over the network;
establishing a smart contract between the account of the first user and the account of the second user, based on the requested calendar slot, and including the received blockchain token;
verifying a smart contract trigger, based on the communication type; and
executing the smart contract after the calendar slot has elapsed by transferring the received blockchain token from the account of the second user to the account of the first user.

9. The non-transitory computer-readable medium of claim 8 wherein the communication type is at least one of, audio, video, and text.

10. The non-transitory computer-readable medium of claim 8 wherein the communication type is in person, and wherein the smart contract trigger is a geo location proximity trigger between the mobile device of the first user and the mobile device of the second user.

11. The non-transitory computer-readable medium of claim 9 wherein the communication type is audio and at the time of the calendar slot, allowing an audio connection between the application running on the first mobile device and the application running on the second mobile device for the calendar slot duration.

12. The non-transitory computer-readable medium of claim 9 wherein the communication type is text and at the time of the calendar slot, allowing a text connection between the application running on the first mobile device and the application running on the second mobile device for the calendar slot duration.

13. The non-transitory computer-readable medium of claim 9 wherein the communication type is video and at the time of the calendar slot, allowing a video connection between the application running on the first mobile device and the application running on the second mobile device for the calendar slot duration.

14. The non-transitory computer-readable medium of claim 8 further comprising, via the computer server,
receiving a bid amount from the first user associated with the calendar slot;
allowing multiple users to bid on the calendar slot;
accepting the highest bid from the second user for the time slot, before receiving the blockchain token from the account associated with the second user.
